(19) United States
(12) Patent Application Publication
(10) Pub. No.: US 2017/0335133 A1
(43) Pub. Date: Nov. 23, 2017

(54) BINDER COMPOSITION AND A PAINT FORMULATION MADE THEREOF

(71) Applicants: Dow Global Technologies LLC, Midland, MI (US); Rohm and Haas Company, Philadelphia, PA (US); UCAR Emulsion Systems FZE, Dubai (AE)

(72) Inventors: Shiling ZHANG, Shanghai (CN); Dong YUN, Shanghai (CN); Yujiang WANG, Shanghai (CN); Caifeng WANG, Shanghai (CN); Lukasz ZUKOWSKI, Dubai (AE); Hui LIU, Shanghai (CN); Ling LI, Shanghai (CN)

(21) Appl. No.: 15/526,381

(22) PCT Filed: Nov. 19, 2014
(86) PCT No.: PCT/CN2014/091562

§ 371 Date: May 12, 2017

(51) Int. Cl. C09D 157/06; C09D 5/29

(52) U.S. Cl. CPC C09D 157/06; C09D 5/29

(57) ABSTRACT

The present invention further provides a binder composition comprising a first binder and a second binder, wherein the first binder comprises, by dry weight based on total dry weight of the binder composition, from 5% to 98% polymer particles, from 0.3% to 20% a first polysaccharide, and from 0.1% to 20% a colorant; and the second binder comprises, by dry weight based on total dry weight of the binder composition, from 0.05% to 5% a crosslinker. The present invention further provides a paint formulation comprising the binder composition.

### FIELD OF THE INVENTION

The present invention relates to a binder composition, in particular, a two-package binder composition. The present invention further relates to a paint formulation, in particular, a multi-color paint formulation comprising the binder composition.

### INTRODUCTION

The paint industry now has increased needs for paint appearances meeting special customer requirements. Both conventional single-color paints and multi-color paints are being designed for customized appearances. Conventional single-color paints contain one colorant, while multi-color paints contain at least two colorants with different colors. Before applications, the colorants shall be well and stably distributed and protected in the paints so as to provide required paint film appearances with conventional operation methods such as spraying, brushing and rolling.

The present invention provides a binder composition for paint formulations where after conventional operations such as brushing, rolling, and spraying, the colorants are protected in the globules of the binder composition and bring to the paint film a special appearance that is desired in the art.

### SUMMARY OF THE INVENTION

The present invention provides a first binder comprising by dry weight based on total dry weight of the first binder, from 5.2% to 98.2% polymer particles, from 0.35% to 20.5% a first polysaccharide, and from 0.12% to 20.5% a colorant.

The present invention further provides a binder composition comprising a first binder and a second binder, wherein the first binder comprises, by dry weight based on total dry weight of the binder composition, from 5% to 98% polymer particles, from 0.3% to 20% a first polysaccharide, and from 0.1% to 20% a colorant; and the second binder comprises, by dry weight based on total dry weight of the binder composition, from 0.05% to 5% a crosslinker.

The present invention further provides a paint formulation comprising the binder composition.

### DETAILED DESCRIPTION OF THE INVENTION

The binder composition of the present invention comprises a first binder. The binder composition of the present invention further comprises a second binder.

The First Binder

The first binder of the present invention comprises by dry weight based on total dry weight of the binder composition, from 5% to 98%, preferably from 10% to 90%, and more preferably from 15% to 85%, polymer particles. The polymer particles are from 5.2% to 98.2%, preferably from 10.5% to 90.5%, and more preferably from 15.5% to 85.5% by dry weight based on total dry weight of the first binder.

The polymer particles comprise, as polymerization units, at least one α,β-ethylenically unsaturated nonionic monomer that is α,β-ethylenically unsaturated monomer without bearing an ionic charge between pH=1-14. Suitable examples of the α,β-ethylenically unsaturated nonionic monomers include (meth)acrylic ester monomers, i.e., methacrylic ester or acrylic ester monomers including methyl acrylate, ethyl acrylate, butyl acrylate, 2-ethylhexyl acrylate, decyl acrylate, lauryl acrylate, methyl methacrylate, butyl methacrylate, isodecyl methacrylate, and lauryl methacrylate; (meth)acrylonitrile; styrene and substituted styrene such as α-methyl styrene, and vinyl toluene; butadiene; ethylene; propylene; α-olefin such as 1-decene; vinyl esters such as vinyl acetate, vinyl butyrate, and vinyl versatate; and other vinyl monomers such as vinyl chloride and vinylidene chloride. Preferably, the α,β-ethylenically unsaturated nonionic monomers are ethyl acrylate, methyl methacrylate, 2-hydroxybutyl acrylate, 2-hydroxyethyl methacrylate, 2-hydroxypropyl methacrylate, vinyl acetate, acrylonitrile, and any combination thereof.

Optionally, the polymer particles further comprise, as polymerization units, from 0.1% to 10%, and preferably from 0.5% to 5% by dry weight based on total dry weight of the polymer particles, an ethylenically unsaturated monomer carrying at least one functional group selected from carboxyl, carboxylic anhydride, hydroxyl, amide, amino, ureido, acetoacetate, sulphonate, phosphonate, and any combination thereof. Suitable examples of these monomers are ethylenically unsaturated carboxylic or dicarboxylic acid such as acrylic or methacrylic acid, itaconic acid, and maleic acid; ethylenically unsaturated amide such as (meth)acrylamide; ethylenically unsaturated N-alkylolamide such as N-methylol(meth)acrylamide and 2-hydroxyethyl(meth)acrylamide; hydroxyalkyl ester of the carboxylic or dicarboxylic acid, such as hydroxyethyl (meth)acrylate and hydroxypropyl (meth)acrylate; amino-functional monomers such as N,N-dimethylaminoethyl methacrylate; ureido-functional monomers such as methacrylamidoethyl-2-imidazolidinone; monomers bearing acetoacetate-functional groups such as acetoacetoxyethyl methacrylate; and any combination thereof.

The first binder further comprises by dry weight based on total dry weight of the binder composition, from 0.3% to 20%, preferably from 0.5% to 16%, and more preferably from 0.8% to 10%, a first polysaccharide. The first polysaccharide is from 0.35% to 20.5%, preferably from 0.6% to 17%, and more preferably from 0.85% to 10.5% by dry weight based on total dry weight of the first binder.

The first polysaccharides are any galactomannoglycans, and include guar gum, guar derivatives such as hydroxypropyl guar and carboxymethyl hydroxypropyl guar, locust bean gum, tara gum, and any combination thereof. Preferably, the first polysaccharide is guar gum or guar derivatives.

The first binder further comprises by dry weight based on total dry weight of the binder composition, from 0.1% to 20%, preferably from 0.3% to 8%, and more preferably from 0.5% to 6%, a colorant. The colorant is from 0.12% to 20.5%, preferably from 0.35% to 8.5%, and more preferably from 0.6% to 6.5% by dry weight based on total dry weight of the first binder.

The colorants are organic or inorganic colorant particles, and preferably are inorganic colorant particles. Suitable examples of the colorant particles include carbon black, lampblack, black iron oxide, red iron oxide, transparent red oxide, yellow iron oxide, transparent yellow oxide, brown iron oxide, phthalocyanine green, phthalocyanine blue, naphthol red, quinacridone red, quinacridone magenta, quinacridone violet, DNA orange, and organic yellow.

Optionally, the first binder further comprises by dry weight based on total dry weight of the binder composition, from 0.1% to 10%, preferably from 0.3% to 8%, and more preferably from 0.5% to 5%, a second polysaccharide. The second polysaccharide is from 0.12% to 10.5%, preferably from 0.35% to 8.5%, and more preferably from 0.6% to 5.5% by dry weight based on total dry weight of the first binder.

Suitable examples of the second polysaccharide include methylcellulose (MC), hydroxypropylmethylcellulose (HPMC), hydroxyethylmethylcellulose (HEMC), hydroxybutylmethylcellulose (HBMC), hydroxyethylethylcellulose (HEEC), carboxymethylcellulose (CMC), agar, starch, alginate, gellan gum, xanthan gum, pectin, carrageenan, gelatin, gum arabic, tragacanth gum, algin, any derivatives thereof, and any combination thereof. Preferably, the second polysaccharide is MC, HPMC, CMC, alginate, and any combination thereof.

Optionally, the first binder further comprises by dry weight based on total dry weight of the binder composition, from 0.1% to 80%, preferably from 2% to 50%, and more preferably from 5% to 40%, pigment particles. The pigment particles are from 0.15% to 80.5%, preferably from 2.2% to 50.5%, and more preferably from 5.2% to 40.5% by dry weight based on total dry weight of the first binder.

The pigment particles refer to inorganic materials which are capable of materially contributing to the opacity (or hiding capability) of a composition. Such materials typically have a refractive index of greater than 1.8, and include titanium dioxide (TiO₂), zinc oxide, zinc sulfide, barium sulfate, barium carbonate, and lithopone. Titanium dioxide (TiO₂) is preferred.

Optionally, the first binder further comprises by dry weight based on total dry weight of the binder composition, from 0.5% to 50%, preferably from 1% to 30%, and more preferably from 3% to 20%, extender particles. The extender particles are from 0.6% to 50.5%, preferably from 1.5% to 30.5%, and more preferably from 3.5% to 20.5% by dry weight based on total dry weight of the first binder.

The extender particles refer to inorganic materials having a refractive index of less than or equal to 1.8 and greater than 1.3, and include calcium carbonate, calcium sulfate, aluminosilicate, silicate, zeolite, mica, diatomaceous earth, Al₂O₃, zinc phosphate, solid or hollow glass, and ceramic beads.

Optionally, the first binder further comprises by dry weight based on total dry weight of the binder composition, from 0.05% to 5%, preferably from 0.1% to 3%, and more preferably from 0.2% to 2%, a thickener. The thickener is from 0.05% to 5.2%, preferably from 0.1% to 3.2%, and more preferably from 0.2% to 2.2% by dry weight based on total dry weight of the first binder.

Suitable examples of the thickener include alkali-soluble emulsions (ASE), hydrophobically modified alkali soluble emulsions (HASE), hydrophobically modified ethylene oxide-urethane polymers (HEUR), hydrophobically modified hydroxyethyl cellulose (HMHEC), hydrophobically modified polyacryamide, and fumed silica.

The Second Binder

The second binder of the present invention comprises by dry weight based on total dry weight of the binder composition, from 0.05% to 5%, preferably from 0.1% to 4%, and more preferably from 0.2% to 2%, a crosslinker.

The crosslinkers can be organotianate compounds, organozirconate compounds, and any combination thereof.

The organotianate compounds include tetraalkyl titanates and titanate chelates. The tetraalkyl titanates have the formula Ti(OR)₄ with R being an alkyl group. Suitable examples of the tetraalkyl titanates include tetraisopropyltitanate, tetra-n-butyltitanate, tetrakis (2-ethylhexyl) titanate, diisopropyl diisosteary titanate, and any combination thereof. The titanate chelates have the following formula (I),

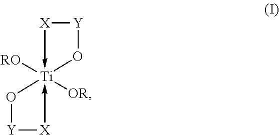

wherein X represents a functional group containing oxygen or nitrogen, Y represents a carbon chain, and R represents an alkyl group. Suitable example of the titanate chelates include acetylacetonate titanate chelate, ethyl acetoacetate titanate chelate, diisopropyl di-triethanolamino titanate chelate, lactic acid titanate chelate (ammonium salt), and any combination thereof.

The organozirconate compounds include tetraalkyl zirconates and zirconate chelates.

The tetraalkyl zirconates have the formula Zr(OR)₄ with R being an alkyl group. Suitable examples of the tetraalkyl zirconates include zirconium tetra-n-butanolate and zirconium tetra-n-propanolate. Suitable examples of the zirconate chelates include triethanolamine zirconate chelate, zirconium triethanolamine and polyol complex, and lactic acid zirconate chelate, and any combination thereof.

Optionally, the second binder further comprises by dry weight based on total dry weight of the binder composition, from 0.1% to 10%, preferably from 0.2% to 8%, and more preferably from 0.5% to 5%, the polymer particles.

Other Optional Components in at Least One of the First and the Second Binders

Optionally, at least one of the first and the second binders of the present invention further comprises by dry weight based on total dry weight of the binder composition, from 0.05% to 10%, preferably from 0.5% to 7.5%, and more preferably from 1% to 5%, clay.

The clay refers to hydrous phyllosilicates with magnesium, aluminum, lithium sodium and other metal elements. Suitable examples of the clay include lithium magnesium silicate commercially available as LAPONITE™ RD and LAPONITE RDS from Rockwood Additives Ltd., aluminum magnesium silicate commercially available as VEEGUM™ from Vanderbilt Company, Inc, and any combination thereof.

Preparation of Either Binder

Either binder of the present invention is prepared by mixing the binder components in water and with stirring. For single-color paints, one colorant is added to the first binder, while for multi-color paints, at least two different colorants are added individually to different first binders. Each first binder comprises only one colorant.

Preparation of the Binder Composition

The binder composition of the present invention is prepared by simply mixing the first binder with the second binder. For multi-color paints, it is preferably that each first binder was mixed with each second binder to prepare different binder compositions. Different binder compositions comprising different first binders comprising different colorants are therefore mixed together to prepare the binder composition for multi-color paints.

The Paint Formulation

The binder composition is made into a paint formulation by mixing the binder composition with other paint additives.

Suitable examples of the paint additives include coalescing agents, cosolvents, surfactants, buffers, neutralizers, thickeners, non-thickening rheology modifiers, dispersants, humectants, wetting agents, mildewcides, biocides, plasticizers, antifoaming agents, defoaming agents, anti-skinning agents, flowing agents, and anti-oxidants.

Paint Operations

The paint formulations may be operated by conventional operation methods including trowel, brushing, rolling, and spraying methods such as air-atomized spray, air-assisted spray, airless spray, high volume low pressure spray, and air-assisted airless spray.

Suitable substrates for such paint operations include concrete board, cement board, medium-density fiber (MDF) board, particle board, gypsum board, wood, stone, metal, plastics, wall paper and textile. Preferably, all the substrates are pre-primed by waterborne or solvent-borne primers.

### Examples

### I. Raw Materials

| Ingredients | Supplier |
|---|---|
| JAGUAR ™ HP-8 hydroxypropyl | Solvay S.A. Company |
| guar (HP-8) | |
| JAGUAR ™ HP-105 hydroxypropyl | Solvay S.A. Company |
| guar (HP-105) | |
| JAGUAR ™ 4500F guar gum | Solvay S.A. Company |
| (4500F) | |
| METHOCEL ™ F 4M | The Dow Chemical Company |
| hydroxypropylmethylcellulose (F | |
| 4M) | |
| WALOCEL ™ CRT 3000 | The Dow Chemical Company |
| carboxymethylcellulose (CRT 3000) | |
| MANUCOL ™ DM alginate (DM) | FMC Company |
| XERACOLOUR ™ blue colorant | ICC International Chemical |
| (blue) | |
| XERACOLOUR ™ red colorant | ICC International Chemical |
| (red) | |
| XERACOLOUR ™ grey colorant | ICC International Chemical |
| (grey) | Corporation |
| TYZOR ™ LA titanate chelate | Dorf Ketal Company |
| (TYZOR LA) | |
| TYZOR ™ 217 lactic acid zirconate | Dorf Ketal Company |
| chelate (TYZOR 217) | |
| sodium borate | Sinopharm Chemical Reagent |
| | Co., Ltd. |
| CC-700 calcium carbonate (CC-700) | Qingdao Gu Dao Chemical |
| | Materials Co., Ltd. |
| TI-PURE ™ R706 TiO₂ (TiO₂) | E. I. du Pont Company |
| PRIMAL ™ TX-010 acrylic | Dow Chemical Company |
| emulsion (TX-010) | |
| PRIMAL ™ TX-011 acrylic | Dow Chemical Company |
| emulsion (TX-011) | |
| PRIMAL ™ SF-155 acrylic emulsion | The Dow Chemical Company |
| (SF-155) | |
| NATROSOL ™ 250 HBR rheology | Eastman Chemical Company |
| modifier (250 HBR) | |

### II. Test Methods

1. Colorant Protection

The binder composition was prepared by mixing 100 g first binder and 1.7 g second binder and stirring at 10-300 rpm for 10 min Under the role of the crosslinker, the binder composition was observed forming globules in a continuous phase. The resulted binder composition was then further stirred under 600 rpm for 10 min, and colorant protection was observed by naked eyes. If colorants were not released from the globules into the continuous phase or there was no color leaking out of globules and in contact directly in the case of multi-color paints, the colorant was protected; otherwise, the colorant was not protected.

2. Heat Aging Test

300 mL of each paint formulation was added into a 500 mL capped plastic bottle and heated under 50° C. in a Lindberg/Blue M™ vacuum oven of Thermal Electron Corporation for 10 Days. Paint formulations with good colorant protection were observed by naked eyes for gelation or syneresis after heat aging. Paint formulations were stable if neither gelation nor syneresis were observed.

### III. Experimental Examples

1. Preparation of Binder Compositions (Binders) 1 to 7 (for single-color paint), Binder Composition (Binder) 8 (for multi-color paint) and Comparative Binder Compositions (Comparative Binders) 9 to 13

Preparation of the first binder for Binder Composition 1: 0.8 g JAGUAR HP-8 hydroxypropyl guar, 0.4 g METHOCEL F 4M hydroxypropylmethylcellulose, and 0.2 g MANUCOL DM alginate were dispersed in 71.2 g DI water by stirring at 200-1500 rpm for 5 min, and then incubated at 60-90° C. for 10 min with stirring at 500-2000 rpm. The composition was cooled by ice water bath for 10 min, and was kept stirring at 500-2000 rpm. When the polysaccharides were dissolved, 26.4 g PRIMAL TX-011 acrylic emulsion, 1.0 g XERACOLOUR grey colorant were added into the polysaccharide solution with stirring at 2000 rpm for 20 min.

Preparation of the second binder for Binder Composition 1: 3 g TYZOR LA titanate chelat and 30 g PRIMAL TX-010 acrylic emulsion were dispersed in 67 g DI water by stirring at 100-500 rpm for 10 min.

Preparation of Binder Composition 1: 100 g first binder and 1.7 g second binder were mixed by stirring at 10-300 rpm for 10 min.

The first and the second binders for Binder Compositions 2 to 7 and Comparative Binder Compositions 9 to 13 were prepared according to the above process of preparation for the first and the second binders for Binder Composition 1, with detailed binder components listed in Table 1.

Binder Compositions 1 to 7 and Comparative Binder Compositions 9 to 13 were prepared by mixing corresponding first binder and second binder and stirred at 10-300 rpm for 10 min.

Binder Composition 8 was prepared by mixing at a ratio of 4:5:1 of three different binder compositions each comprising one different red, blue or grey colorant prepared according to the procedure of making Binder Composition 6.

2. Preparation of Single-Color Paint Formulations (Paint) 1 to 7, Multi-Color Paint Formulation (Paint) 8 and Comparative Paint Formulations (Comparative Paints) 9 to 13

Preparation of Paint Formulation 1 (Paint 1) from Binder Composition 1: 100 g Binder Composition 1 was dispersed in 10 g NATROSOL 250 HBR rheology modifier (1% solution) to make the single-color Paint Formulation 1. Paint Formulations 2 to 7, and 8, and Comparative Paint Formulations 9 to 13 were prepared from Binder Compositions 2 to 7, and 8, and Comparative Binder Compositions 9 to 13, respectively, according to the above process of preparation for Paint Formulation 1.

TABLE 1-a

| Binders | | Binder 1 | Binder 2 | Binder 3 | Binder 4 |
|---|---|---|---|---|---|
| First | First | 5.0% (5.1%)* | 3.1% (3.1%)* | 6.3% (6.4)* | 0.8% (0.8%)* |
| binder | Polysaccharide | HP-8 | HP-105 | HP-105 | 4500F |
| | Second | 1.2% (1.3%)* | — | — | — |
| | Polysaccharide | DM | | | |
| | | 2.5% (2.5%)* | 1.5% (1.6%)* | — | 0.7% (0.7%)* |
| | | F 4M | CRT 3000 | | F 4M |
| | Polymer | 83.6% (84.8%)* | 51.3% (52.3%)* | 83.5% (85.1%)* | 66.5% (66.8%)* |
| | particles | TX-011 | TX-011 | SF-155 | TX-010 |
| | Extender | — | 38.3% (39.1%)* | — | 24.9% (25.0%)* |
| | | | CC-700 | | CC-700 |
| | Pigment | — | — | 8.4% (8.5%)* | 5.0% (5.0%)* |
| | | | | TiO₂ | TiO₂ |
| | Colorant | 6.2% (6.3%)* | 3.8% (3.9%)* | 1.5% (1.5%)* | 1.7% (1.7%)* |
| | | grey | red | red | blue |
| Second | Crosslinker | 0.3% | 0.2% | 0.4% | 0.1% |
| binder | | TYZOR LA | TYZOR 217 | TYZOR LA | TYZOR LA |
| | Polymer | 1.1% TX-010 | 0.7% TX-010 | 1.4% TX-011 | 0.3% TX-010 |
| | particles | | | | |

*% is dry weight percentage based on total dry weight of the binder composition, unless otherwise indicated within the parenthese, which is dry weight percentage based on total dry weight of the first binder.

TABLE 1-b

| | | | | | Comparative |
|---|---|---|---|---|---|
| Binders | | Binder 5 | Binder 6 | Binder 7 | Binder 9 |
| First | First | 6.4% (6.7%)* | 14.8% | 14.4% | 0.8% (0.8%)* |
| binder | Polysaccharide | HP-105 | (15.6%)* HP-8 | (14.5%)* HP-8 | 4500F |
| | Second | 1.6% (1.7%)* | 2.2% (2.3%)* | 2.2% (2.3%)* | — |
| | Polysaccharide | DM | CRT 3000 | CRT 3000 | |
| | | 3.2% (3.4%)* | — | — | 0.7% (0.7%)* |
| | | F 4M | | | F 4M |
| | Polymer | 80% (84%)* | 74.1% | 79.1% | 66.6% |
| | particles | TX-010 | (78.1%)* TX- | (79.7%)* TX- | (66.8%)* TX- |
| | | | 010 | 010 | 010 |
| | Extender | — | — | — | 24.9% (25%)* |
| | | | | | CC-700 |
| | Pigment | — | — | — | 5% (5%)* TiO₂ |
| | Colorant | 4% (4.2%)* | 3.7% (3.9%)* | 3.6% (3.6%)* | 1.7% (1.7%)* |
| | | grey | red | red | blue |
| Second | Crosslinker | 0.8% TYZOR | 1.5% | 0.7% | 0.02% |
| binder | | LA | TYZOR 217 | TYZOR LA | TYZOR LA |
| | Polymer | 4% TX-011 | 3.7% TX-011 | — | 0.3% TX-010 |
| | particles | | | | |

*% is dry weight percentage based on total dry weight of the binder composition, unless otherwise indicated within the parenthese, which is dry weight percentage based on total dry weight of the first binder.

TABLE 1-c

| | | Comparative | Comparative | Comparative | Comparative |
|---|---|---|---|---|---|
| Binders | | Binder 10 | Binder 11 | Binder 12 | Binder 13 |
| First | First | 5.0% (5.1%)* | 3.1% (3.1%)* | 6.4% (6.7%)* | 0.1% (0.1%)* |
| binder | Polysaccharide | HP-8 | HP-105 | CRT 3000 | HP-105 |
| | Second | 1.3% (1.3%)* | — | 1.6% (1.7%)* | — |
| | Polysaccharide | DM | | DM | |
| | | 2.5% (2.5%)* | 1.50% (1.6%)* | 3.2% (3.4%)* | 1.6% (1.6%)* |
| | | F 4M | CRT 3000 | F 4M | CRT 3000 |
| | Polymer | 83.9% (84.8%)* | 52.4% (52.3%)* | 80% (84%)* | 53.5% (54%)* |
| | particles | TX-011 | TX-011 | TX-010 | TX-011 |
| | Extender | — | 38.7% (39.1%)* | — | 39.9% (40.3%)* |
| | | | CC-700 | | CC-700 |
| | Pigment | — | — | — | — |
| | Colorant | 6.3% (6.3%)* | 3.9% (3.9%)* | 4% (4.2%)* | 4.0% (4.0%)* |
| | | grey | red | grey | red |
| Second | Crosslinker | — | 0.2% | 0.8% | 0.2% |
| binder | | | sodium borate | TYZOR LA | TYZOR 217 |
| | Polymer | 1.1% TX-010 | 0.7% TX-010 | 4% TX-011 | 0.7% TX-010 |
| | particles | | | | |

*% is dry weight percentage based on total dry weight of the binder composition, unless otherwise indicated within the parenthese, which is dry weight percentage based on total dry weight of the first binder.

### IV. Results

TABLE 2

| | | Colorant | Heat |
|---|---|---|---|
| Paints | Binders | protection | aging test |
| Paint 1 | Binder 1 | Protected | Stable |
| Paint 2 | Binder 2 | Protected | Stable |
| Paint 3 | Binder 3 | Protected | Stable |
| Paint 4 | Binder 4 | Protected | Stable |
| Paint 5 | Binder 5 | Protected | Stable |
| Paint 6 | Binder 6 | Protected | Stable |
| Paint 7 | Binder 7 | Protected | Stable |
| Paint 8 | Binder 8 | Protected | Stable |
| Comparative Paint 9 | Comparative Binder 9 | Not protected | — |
| Comparative Paint | Comparative Binder | Not protected | — |
| 10 | 10 | | |
| Comparative Paint | Comparative Binder | Protected | Gelation |
| 11 | 11 | | |
| Comparative Paint | Comparative Binder | Not protected | — |
| 12 | 12 | | |
| Comparative Paint | Comparative Binder | Not protected | — |
| 13 | 13 | | |

Comparative Binder Composition 10 (Comparative Binder 10) did not comprise any crosslinker in its second binder, and Comparative Binder Composition 11 (Comparative Binder 11) comprised a non-recommended crosslinker (0.2% sodium borate) in its second binder. Comparative Binder 10 did not protect colorant in its first binder, and Comparative Binder 11 although protected colorant in its binder composition, but Comparative Paint 11 made from Comparative Binder 11 was not stable and it gelled. The result indicated that properly selected crosslinkers played a critical role to the binders' colorant protection and the paints' heat aging stability.

Comparative Binder Composition 9 (Comparative Binder 9) comprised insufficient amount of crosslinker in its second binder, and did not protect the colorant. The result indicated that the crosslinker's usage had to be higher than a selected level to achieve percentage binders' colorant protection performance.

Comparative Binder Compositions 12 and 13 (Comparative Binders 12 and 13) respectively comprised non-recommended first polysaccharide and insufficient amount of the recommended first polysaccharide in their first binders, and both of their binder compositions did not protect the colorant. The result indicated that the first polysaccharide component and its percentage were both critical to binders' colorant protection performance.

Binder Composition Examples 1 to 8 comprised respectively proper amounts of recommended components of the present invention, and showed good colorant protection performances and Paint Formulations 1 to 8 made from Binder Compositions 1 to 8 all showed good paint stabilities. Paint Formulations 1 to 7 were single-color paints while Paint Formulation 8 was a multi-color paint, both achieved the requirements of the present invention.

What is claimed is:

1. A binder composition comprising a first binder comprising by dry weight based on total dry weight of the first binder, from 5.2% to 98.2% polymer particles, from 0.35% to 20.5% a first polysaccharide, and from 0.12% to 20.5% a colorant.

2. The binder composition according to claim 1 wherein the first binder further comprises from 0.12% to 10.5%, by dry weight based on total dry weight of the first binder, a second polysaccharide.

3. The binder composition according to claim 1 wherein the first binder further comprises from 0.15% to 80.5%, by dry weight based on total dry weight of the first binder, pigment particles.

4. The binder composition according to claim 1 wherein the first binder further comprises from 0.6% to 50.5%, by dry weight based on total dry weight of the first binder, extender particles.

5. The binder composition according to claim 1 wherein the first binder further comprises from 0.05% to 5.2%, by dry weight based on total dry weight of the first binder, a thickener.

6. A binder composition comprising a first binder and a second binder, wherein the first binder comprises, by dry weight based on total dry weight of the binder composition, from 5% to 98% polymer particles, from 0.3% to 20% a first polysaccharide, and from 0.1% to 20% a colorant; and the second binder comprises, by dry weight based on total dry weight of the binder composition, from 0.05% to 5% a crosslinker.

7. The binder composition according to claim 6 wherein the first binder further comprises from 0.1% to 10%, by dry weight based on total dry weight of the binder composition, a second polysaccharide.

8. The binder composition according to claim 6 wherein the first binder further comprises from 0.1% to 80%, by dry weight based on total dry weight of the binder composition, pigment particles.

9. The binder composition according to claim 6 wherein the first binder further comprises from 0.5% to 50%, by dry weight based on total dry weight of the binder composition, extender particles.

10. The binder composition according to claim 6 wherein the first binder further comprises from 0.05% to 5%, by dry weight based on total dry weight of the binder composition, a thickener.

11. The binder composition according to claim 6 wherein the second binder further comprises from 0.1% to 10%, by dry weight based on total dry weight of the binder composition, polymer particles.

12. The binder composition according to claim 6 wherein at least one of the first and the second binders further comprises from 0.05% to 10%, by dry weight based on total dry weight of the binder composition, clay.

13. A paint formulation comprising the binder composition according to claim 6.
